(19) United States
(12) Patent Application Publication
(10) Pub. No.: US 2023/0360323 A1
(43) Pub. Date: Nov. 9, 2023

(54) SYSTEMS AND METHODS FOR THE GENERATING CONTENT OVERLAYS FOR VIRTUAL REALITY SYSTEMS

(71) Applicant: SB22, Inc., Dallas, TX (US)

(72) Inventors: Vladimir Jovanovic, Belgrade (RS); Marko Savkovic, Belgrade (RS)

(21) Appl. No.: 18/314,366

(22) Filed: May 9, 2023

Related U.S. Application Data
(60) Provisional application No. 63/364,386, filed on May 9, 2022.

(51) Int. Cl. G06T 17/00; H04N 5/265; G06F 3/01

(52) U.S. Cl. CPC G06T 17/00; H04N 5/265; G06F 3/017

(57) ABSTRACT

Aspects of the present disclosure relate to using a virtual reality (VR) device to expand viewing options of an event by combining multiple video streams of the event with interactive overlays. In examples, a viewer utilizing a VR device may view an event from a plurality of camera angles associated with the event. Further, one or more overlays containing interactive elements associated with the content and the viewing experience may be presented to the user on the content stream of the event without the user having to transition to a separate screen or device. The overlays may be generated based on one or more interest indicators and may be selected to trigger a workflow. Ultimately, the overlays and additional viewing angles enhance the users experience without diminishing the underlying viewing experience.

### CROSS-REFERENCE TO RELATED APPLICATION

This application claims priority to U.S. Provisional Application No. 63/364,386, titled “SYSTEMS AND METHODS FOR THE GENERATION OF GAMING OPPORTUNITIES FOR DISPLAY ON DEVICES HAVING DIFFERING FORM FACTORS” filed on May 9, 2022, the entire disclosure of which is hereby incorporated by reference in its entirety.

### BACKGROUND

Streaming options across a plurality of devices have expanded the opportunities for individuals to participate virtually from across the globe with events that are occurring in real-time elsewhere. The problem is that when you participate in an event virtually it is difficult to participate in the experience in an immersive way. Often, this is the result of technological limitations relating to the user's content viewing device. The limitations may include being restricted to a single viewing angle or viewing position of the event and having to transition to a separate device to engage with interactive elements associated with the event. The result is that users have a disrupted viewing experience which ultimately limits their enjoyment of the event and the panoply of interactive elements associated with the event.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to an immersive event experience using a virtual reality (VR) device to expand a user's viewing options of an event by combining multiple video streams of the event with overlays of interactive elements associated with the event experience. In examples, a viewer utilizing a VR device may view an event from a plurality of camera angles associated with the event. In this way, the user is not restricted to a single viewing angle as in traditional content streaming options. Further, one or more overlays containing interactive elements associated with the content and the viewing experience may be presented to the user on the content stream of the event without the user having to transition to a separate screen or device. Thus, the user can continue enjoying the event while concurrently taking advantage of the interactive elements presented in the overlay. The overlays may be generated based on one or more interest indicators, and moments that occur during the event. Selection of an interactive element within an overlay may trigger one or more workflows which will transition the overlay presentation while maintaining users view of the underlying event stream. Ultimately, the user may have a series of overlays presented on the VR device to enhance the event experience without diminishing the underlying viewing experience.

This summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary event overlay system, according to aspects described herein.

FIG. 2 depicts an exemplary user interface for a VR device, according to aspects described herein.

FIG. 3 depicts an exemplary overlay for an event with interactive elements for a VR device, according to aspects described herein.

FIG. 4 depicts an exemplary overlay for an event with interactive elements for generating and purchasing an NFT on a VR device, according to aspects described herein.

FIG. 5 depicts yet another exemplary overlay for an event with interactive elements for a VR device, according to aspects described herein.

FIG. 6 is a block diagram illustrating a method for generating an overlay for an event on a VR device, according to aspects described herein.

FIG. 7 is a block diagram illustrating a method for performing a workflow associated with betting interactive elements, according to aspects described herein.

FIG. 8 is a block diagram illustrating a method for geo-locating the VR device, according to aspects described herein.

FIG. 9 is a block diagram illustrating a method for performing a workflow associated with making a purchase via the VR device, according to aspects described herein.

FIG. 10 is a block diagram illustrating a method for performing a workflow associated with creating a non-fungible token, according to aspects described herein.

FIG. 11 depicts an exemplary console overlay for a VR device, according to aspects described herein.

FIG. 12 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

The streaming wars have created a cluttered landscape full of content types and various platforms to access the content. Unfortunately, the platforms rarely offer distinct methods for viewing and interacting with the content they provide. Streaming options are limited to traditional viewing techniques which have existed in television and movies for decades. Users are constrained to viewing a single display as a two-dimensional format where the camera position is determined for the user and the control device is a physical piece of hardware external to the display (e.g., television set, gaming system) or a touch screen on the device (e.g., mobile device, tablet, etc.). As a result, users are limited in their content viewing experience and the method of experiencing the content to viewing technologies that have remained largely static from an interactive perspective for some time.

To address these identified issues, aspects of the present disclosure relate to a VR interface having interactive elements overlaying the content stream which permit the user to view and enjoy the content while engaging with an overlay's interactive elements. A user may choose to view a content stream virtually on a VR device. The content stream may be a live event (e.g., a sports game, concert, political event, etc.) or a recorded event (e.g., movie, television show, replay of a sports game, etc.). In examples, the system may generate and display one or more overlays having a plurality of interactive elements to engage the user during their viewing of the content stream. The overlays may be provided in addition to the content stream such that they may exist as a transparent layer between the content and the user, wherein the overlay does not disrupt the viewing experience of the content stream. Rather, the overlay enhances the users experience by providing an immersive format that in some cases may exceed traditional experiences offered by a movie theater or stadium style event.

Overlays may provide a variety of experiences for the user to interact with. For example, an overlay may provide shopping options for the user purchase that are associated with the content. In another example, the overlay could have interactive elements related to viewing and placing bets as live betting or pre-event bets. In further examples, the overlay could be related to food options that the user could view and purchase for delivery to their location. In still further examples, the overlay could provide interesting and/or useful information relating to the content to enhance the users viewing experience and situational awareness of the content. In another example, the overlay could relate to a non-fungible token (NFT) generated from a moment occurring during the content and provided for the users purchase. In each example the overlay may be provided with one or more interactive elements to which the user can provide gesture inputs to control. Those having skill in the art will appreciate the immense variety of overlays and interactive elements which could be provided to enhance the user's experience of the content in VR.

In addition to the overlays, the system enhances the user's perspective of the content by offering multiple viewing perspectives of the content. For example, often stadiums, theaters, arenas, and other event locations are equipped with cameras in different areas capturing a plurality of viewpoints of the content. One camera may be a close-up view, such as sitting courtside at a basketball game, while another might be a traditional perspective view of the game. In examples, the user has the option to select various viewing orientations from the available camera angles used to capture the event. However, the option to select an alternative viewing perspective is not limited to live content but is available for each type of content that includes multiple viewing perspectives. When the user selects a different viewing perspective if an overlay is presented on the display, it may transition with the user's choice, potentially being modified to adapt to the adjusted viewing perspective. This gives users more control over the viewing experience enabling them to view content as if they were present at the event. In examples, the overlay and viewing angle selection, are provided in a VR device which may respond to gesture input and/or voice command, thereby eliminating the need for multiple devices and/or multiple screens to perform a workflow such as purchasing an item, placing a bet, or ordering food.

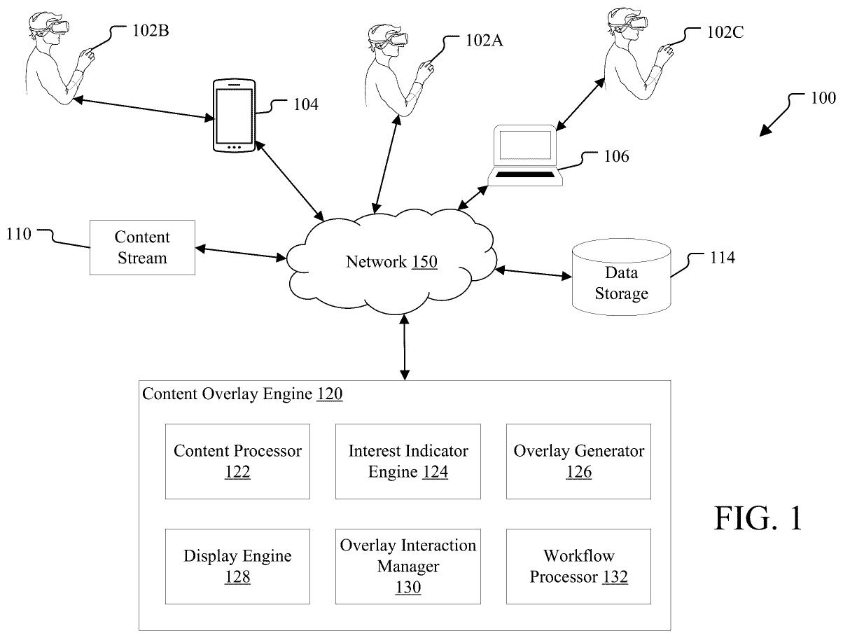

FIG. 1 depicts an exemplary event overlay system, according to aspects described herein. System 100 includes VR devices 102A-102C, mobile device 104, a computing device 106, content stream 110, data storage 114, and content overlay engine 120. Each of the VR devices 102A-102C, mobile device 104, a computing device 106, content stream 110, and data storage 114 may be connected on a network 150 via a Wi-Fi connection or a cellular data connection. Network 150 may be any type of network, such as, for example, a LAN, a WAN, a near-field communications network, a cellular broadband network, point-to-point network, a Wi-Fi network, enterprise network, the Internet, etc. and may include one or more of wired, wireless, and/or optical portions.

System 100 includes several configurations for accessing content overlay engine 120, content stream 110, and data storage 114 over network 150. In some examples, an all-in-one VR device 102A may be utilized that receives the content stream 110 and communicates with data storage 114 and content overlay engine 120 directly over the network 150. In other examples, an intermediate device mobile device 102 securely connected to VR device 102B or a computing device 106 securely connected to VR device 102C may be utilized to communicate over the network 150. For ease of discussion, a single VR device 102 will be referenced as encompassing each of these configurations.

Content overlay engine 120 is operable to connect to any number of VR devices 104 to generate one or more overlays for a content stream, present a plurality of interactive elements within an overlay, and receive requests to perform a variety of workflows based on gesture input and/or input via a physical device. The content overlay engine 120 includes a content processor 122, interest indicator engine 124, overlay generator 126, display engine 128, overlay interaction manager 130, and workflow processor 132. In examples, a user may access a content stream on a VR device 102 via the network 150.

The content processor 122 may access the content stream and determine the type of content the user is viewing (e.g., a live event, sporting event, recorded content, video game, etc.) and format it for presentation on the VR device 102 including one or more overlays. The content processor 122 may establish a secure connection with the various elements of system 100. In examples, the secure connection may be established directly between a VR device 102, the content stream 110, and content overlay engine 120. The secure connection may be established using an encrypted or otherwise secure communications protocol, such as HTTPS. Alternatively, in examples utilizing an intermediate device, such as a mobile device 104 connected to the VR device 102, the intermediate device may establish a secure connection. In examples, user authentication may be performed when establishing the secure connection. For example, a username and password and/or form of biometric identification for an account associated with the content stream 110 may be provided with, or after, the request to establish a secure connection. Alternatively, data stored by the VR device 102 or intermediate device, such as a cookie or a certificate, may be used to authenticate the user.

The interest indicator engine 124 may analyze one or more interest indicators to provide personalize the overlays and interactive elements within the overlays to generate user interest and increase user engagement. The interest indicator engine 124 may gather information relating to one or more interest indicators such as content stream information, user profile information, user history information, user eye gaze information, product information, and/or common user characteristic information. Content stream information relates to information associated with the content stream which may be applicable to the user (e.g., apparel worn by a player or performer for sale in the online store, contextual information that could be used in an information overlay, etc.). In examples, the user may have a profile created and stored in data storage 114 including user preferences for various content types, overlays, stylistic options, etc. as well as user information, payment information, a user account with money deposited, and/or user history information. The payment information may be configured to accept a plurality of monetary options including a variety of currency types (e.g., dollars, pounds, euro, cryptocurrency, etc.) may be linked to a bank account and/or credit card, etc.

In examples where the user is new and/or there is limited personal information relating to the user or their history, the interest indicator engine 124 may recommend overlays that would be generated based on common user preferences and product information. In examples, one or more aspects of artificial intelligence and/or machine learning may be utilized to analyze the interest indicators. Thus, the interest indicator engine 124 facilitates overlay and interactive element generation by focusing the overlay on interactive elements, products, and activities that are more likely to be interesting to the user based on both common interests (e.g., what other users prefer for this content) and/or personalized preferences from the user profile. The interest indicator engine 124 may apply one or more aspects of artificial intelligence and or machine learning to identify what the user would be interested in.

For example, if the content is a sports event like a basketball game, the user may be interested in participating in live betting of the game. The interest indicator engine 124 may recognize that the user has a betting history of betting quarter totals with a preference for their favorite team hitting the over. The interest indicator engine 124 may analyze the content and context of the game and determine quarter totals and odds for the totals applicable for the user. In another example, the user could be viewing a fashion show where the models are wearing a certain outfit. The interest indicator engine 124 could gather information relating to the outfit and provide that to the overlay generator 126 for the user to make a purchase in the online shop.

The overlay generator 126 may generate the overlay, based on the analysis of the interest indicator engine 124 with associated interactive elements. The generated overlays may include one or more interactive elements which the user can interact with via gesture input and/or physical device input. In this example, the overlay may include a console with yes or no selectable buttons in addition to coins associated with a monetary value for placing a bet of a certain amount. In other examples, the overlay may not contain interactive elements but just additional content for viewing by the user. For example, in the basketball game, an overlay may be generated presenting a player's current statistics for the game as an informational overlay without associated interactive elements. The overlays may be transparent and/or translucent based on user preferences, system preferences, and/or content options.

In another example, the content may be a sporting game of any kind. The interest indicator engine 124 may identify based on past viewing history of the user that at halftime of similar sporting games, the user orders food for delivery by a food delivery service. The interest indicator engine 124 may analyze this pattern to determine that a one or more types of food are commonly ordered or that a particular food delivery service is commonly used. The overlay generator 126 may use this information to generate overlays with associated interactive elements prompting the user with the overlay “Feeling hungry? Food delivery service is available now.” The user may select an interactive element to order food via the food delivery service which will be recognized by the overlay interaction manager 130. The overlay interaction manager 130 processes the inputs provided as gesture input and/or physical input on a physical device by utilizing the capabilities inherent to the VR device 102.

The interest indicator engine 124 may also determine user interest by utilizing gaze tracking aspects of the VR device 102 to identify what the user is focusing on in the content and tailor the overlays towards that aspect of the content. For example, if the content is a basketball game and the user's gaze tracks a particular player A throughout the game, the interest indicator engine 124, may identify this occurrence and offer interactive live betting options based on this players performance. Thus, the interest indicator engine 124 may pass this information to the overlay generator 126 such that the next time player A is dribbling on offense a live bet overlay may be offered. The overlay may state “Player A to make the next basket+200, bet now.” The user seeing the overlay may provide a gesture input placing a bet via a separate interactive element, which will be recognized by the overlay interaction manager 130, which recognizes the user input via either gesture input and/or input via physical device.

When an input is received by the overlay interaction manager 130 confirming a selection of an interactive element, the workflow processor 132 performs the workflow associated with the confirmation. A plurality of workflows is contemplated as possible with the system, as one having skill in the art will understand. A few examples of workflows include purchase of an item workflow (e.g., a product from a virtual store, ordering food online, buying an NFT created from the content, etc.), placing a bet, participating in an online chat and/or social media network, changing viewing angle, etc.

Continuing the above live betting example for player A, if a bet is placed the workflow processor 132 will perform a workflow associated with placing a bet. This may include the process of geo-locating the VR device 102 to determine if the user meets relevant regulations to place a bet, and if the user does it will place the bet for the user, deduct monetary value from the use account, and provide a receipt for the bet to the user profile. The content processor 122 will track the occurrence of Player A making the next basket. If player A does make the next basket the workflow processor 132 will update the user account with their winnings, and the overlay generator 126 may provide a congratulatory message confirming the winning bet such as “Congratulations, you won!” Alternatively, if player A does not make the next basket the system may not provide notification to the user, or they may provide a confirming notification such as “Sorry you did not win your bet, better luck next time.”

Additionally, the content processor 122 may determine if additional viewing angles are available for the user to select from. If additional viewing angles are available, the overlay generator 126 may prepare an overlay with interactive elements for presentation on the VR device 102. The overlays may be transparent and/or translucent based on user preferences, system preferences, and/or by content type. In some instances, the interest indicator engine 124, may analyze the available viewing angles to generate a preferred order for the user to select from. This may be determined based on user preferences retrieved from the user profile in data storage 114, and/or based on common viewing angles selected by other users collected from the content stream 110. The interest indicator engine 124 may apply one or more aspects of artificial intelligence and or machine learning to identify if the user would be interested in a viewing angle overlay and/or to create a hierarchy for the offered viewing angles. For example, if the content is a music concert for a band, there may be multiple viewing angles including a lead singer focused camera, front row camera, stadium camera, whole stage camera, traditional camera, rotating camera, etc. The interest indicator engine 124 may determine that the user prefers to select their own viewing angle and create a hierarchy based on the user's preferences on their user profile in addition to the user's past history in selecting viewing angles from previous concerts. The hierarchy may be utilized by the overlay generator 126 when generating the overlay such that the viewing angles will be presented in a hierarchical fashion. In this example, the user may have a preference towards a lead singer focused camera and that may be the hierarchical first option presented, with front row camera second, and whole stage camera third, etc.

The display engine 128 may display the viewing angle options overlay on the VR device 102 and the overlay interaction manager 130 may identify a gesture input and/or physical input from the user selecting a viewing angle from the overlay options. In examples, as will be described further herein, the overlay may include interactive elements corresponding to a button, toggle, swipe, tap, tap and hold, etc. to select an interactive element. When the viewing angle is changed, the content processor 122 will request the updated viewing angle and the display engine 128 will change the displayed content to the selected viewing angle on VR device 102.

In further examples, the interest indicator engine 124 may facilitate the generation of NFTs for the user specifically and/or for all viewers of the content stream generally. In some examples, the interest indicator engine 124 may automatically identify a moment from the content stream which could be used to generate an NFT based on an analysis of one or more interest indicators relating to the content. The NFT could be created from a moment in the content stream such as an action during the content (e.g., a winning score, a slam dunk, a certain dance move during a performance, completing a mission during a video game, etc.) and/or a physical item associated with the content (e.g., the game winning ball, a piece of apparel, etc.). The interest indicator engine 124 would communicate this information to the workflow processor 132 as a request to generate an NFT, which the workflow processor 132 would perform.

Alternatively, the user could directly request an NFT be generated by gesture input and image capture using one or more interactive elements on the console of an overlay. By the manual method, the overlay interaction manager 130 would track and recognize gesture and/or physical input to record a video and/or capture an image using interactive elements. The overlay interaction manager 130 may request an overlay from the overlay generator 126 asking the user if they would like an NFT generated for the captured content. If a confirming input is received requesting an NFT, the workflow processor 132 would perform the associated workflow to generate an NFT.

The display engine 128 may position the one or more overlays for display on the VR device 102. In examples, an overlay may be positioned in a place that does not obscure the user's view of the content. The position of the overlay may be adjusted in real-time as the user changes their viewing angle and/or as the content stream progresses. Computer vision techniques may be utilized to determine the position of a court, field, and/or players where the overlay will enhance the viewing experience. Upon identifying these aspects of the environment, the overlay may automatically be moved to a position that does not overlap, or minimally overlaps, the ongoing content stream. An overlay may be dynamically updated to display interactive elements by the interest indicator engine 124, overlay generator 126, and repositioned by the display engine 128 as the game progresses and/or the user interacts with one or more interactive elements.

The workflow processor 132 may capture the moment from the content stream and information associated with the moment, as well as user attendance information. The workflow processor 132 may then generate an NFT based on the collected information. Each moment may be uniquely identified using the NFT and timestamped. In certain examples, where the NFT is created for multiple users viewing the content stream, a contest may be generated as an overlay by the overlay generator 126 in which VR users can participate. The contest may be entered by placing a wager and then competing in the contest to see who wins the NFT. The contest winner may own the NFT generated for the game moment. In examples where the NFT is generated and associated with a physical item associated with the game, such as a user's ticket, the game winning ball, etc. The physical object can then be certified using blockchain technology, such that a digital certificate can be generated for the physical objects associated with the game. Once generated, the NFT can be offered as an overlay to the user to for viewing and a variety of interaction options.

Although specific types of VR devices 102 have been depicted as part of system 100, one of skill in the art will appreciate that different types of VR and/or augmented reality devices may be employed by the system 100 without departing from the scope of this disclosure. Further, while specific types of user interfaces (e.g., displays) and user interface controls (e.g., gesture control, physical device control, etc.) have been described, one of skill in the art will appreciate that other types of controls or user interfaces may be employed by the system 100 without departing from the scope of this disclosure. For example, an audio and speech interface may be employed and/or a haptic feedback interface may be employed in addition to, or in place of, the system depicted in FIG. 1 without departing from the scope of this disclosure.

VR devices 102A-102C, mobile device 104, and/or computing device 106 may be configured to execute one or more applications and/or services and/or manage hardware resources (e.g., processors, memory, etc.), which may be utilized by users of the devices. The VR devices 102A-102C, mobile device 104, and/or computing device 106 may be able to send and receive content data as input or output which may be, for example from a microphone, an image capture device (e.g., a camera), a global positioning system (GPS), etc., that transmits content data, a computer-executed program that generates content data, and/or memory with data stored therein corresponding to content data. The content data may include visual content data, audio content data (e.g., speech or ambient noise), a viewer-input, such as a voice query, text query, etc., an image, an action performed by a viewer and/or a device, a computer command, a programmatic evaluation gaze content data, calendar entries, emails, document data (e.g., a virtual document), weather data, news data, blog data, encyclopedia data and/or other types of private and/or public data that may be recognized by those of ordinary skill in the art. In some examples, the content data may include text, source code, commands, skills, or programmatic evaluations.

VR devices 102A-102C, mobile device 104, and/or computing device 106 may each include at least one processor, such as content processor 122, that executes software and/or firmware stored in memory. The software/firmware code contains instructions that, when executed by the processor causes control logic to perform the functions described herein. The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the examples, various logic may be implemented in any appropriate fashion and would remain in accordance with the examples herein disclosed

In accordance with some aspects, data storage 114 may be a network server, cloud server, network attached storage (“NAS”) device, or another suitable computing device. Data storage 114 may include one or more of any types of storage mechanism or memory, including a magnetic disc (e.g., in a hard disk drive), an optical disc (e.g., in an optical disk drive), a magnetic tape (e.g., in a tape drive), a memory device such as a random-access memory (RAM) device, a read-only memory (ROM) device, etc., and/or any other suitable type of storage medium. Although only one instance of the data storage 114 is shown in FIG. 1, the system 100 may include two, three, or more similar instances of the data storage 114. Moreover, the network 150 may provide access to other data stores similar to data storage 114 that are located outside of the system 100, in some examples.

In some examples, the network 150 can be any suitable communication network or combination of communication networks. For example, network 150 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, network 150 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

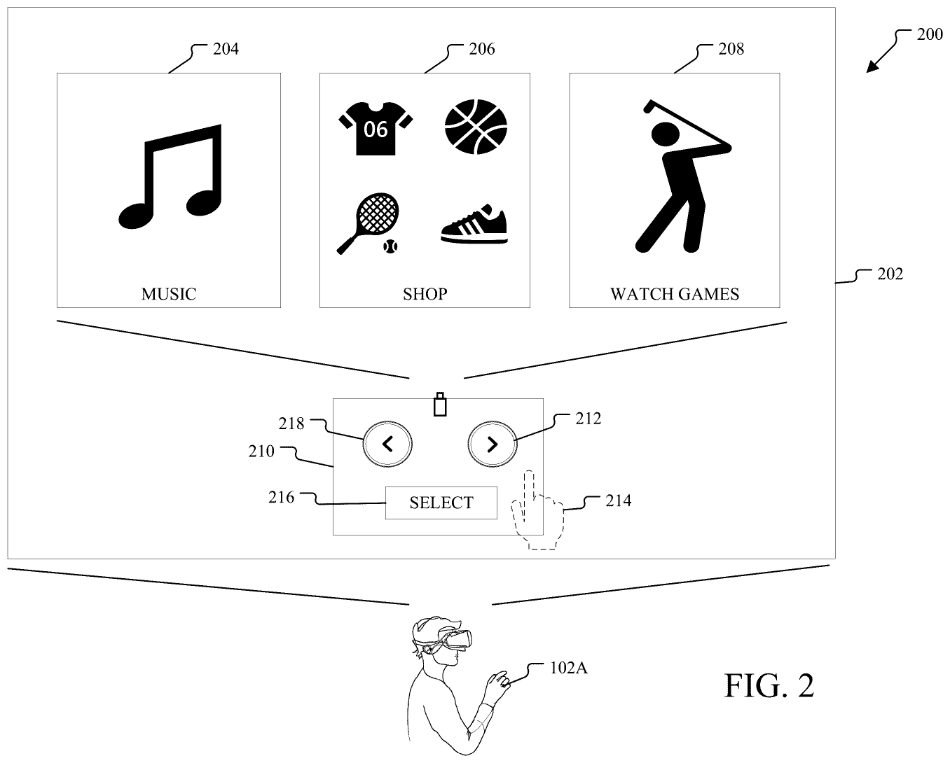

FIG. 2 depicts an exemplary user interface for a VR device, according to aspects described herein. In exemplary environment 200, the user of a VR device, such as VR device 102A, is presented with an options menu overlay 202. The options menu overlay 202 presents the user with one or more interactive elements 204, 206, and 208 from which the user may provide input (e.g., gesture, physical input) to select an interactive element. Interactive element 204 may relate to “Music,” interactive element 206 may link the user to an online shopping option for purchasing items, and interactive element 208 may transition the user to various sports events. In some examples, as seen here, a console 210 may be optionally provided for the user to visualize overlay interaction. The console 210 design may vary based on the type of content, overlays, and/or interactive elements presented. In the present example, the console 210 includes left arrow 218 and right arrow 212 for cycling the interactive elements to other options (e.g., food options, other content options, etc.) There is a select button 216 available for confirming an input as well as a dashed line cursor 214 indicating where the user's gesture is located relative to the interactive elements of the overlay.

For example, the user may want to select interactive element 208 to watch a sports game. To do so the user would provide gesture input to move the cursor 214 over the left arrow 218 and provide a tapping gesture to select it which will scroll the interactive elements to the left, placing watch games in the center. Then the user may provide gesture input to move the cursor 214 over the select button 216 and provide gesture input to select the interactive element 208. In other examples, the user will provide input via gesture or physical device input directly on the interactive element and overlay (e.g., multi-directional swiping, taps, tap and hold, etc.) without the visual indication provided by the console 210. In such an example, the user may select to watch a sports game and provide gesture input to move the cursor 214 over interactive element 208, then provide a tapping gesture or some other such gesture to indicate that they want to select that interactive element. In either example, selecting the interactive element 208, will either open a sub-menu option similar to environment 200 with interactive elements for selection, or it will transition VR device 102 to displaying the selected content stream.

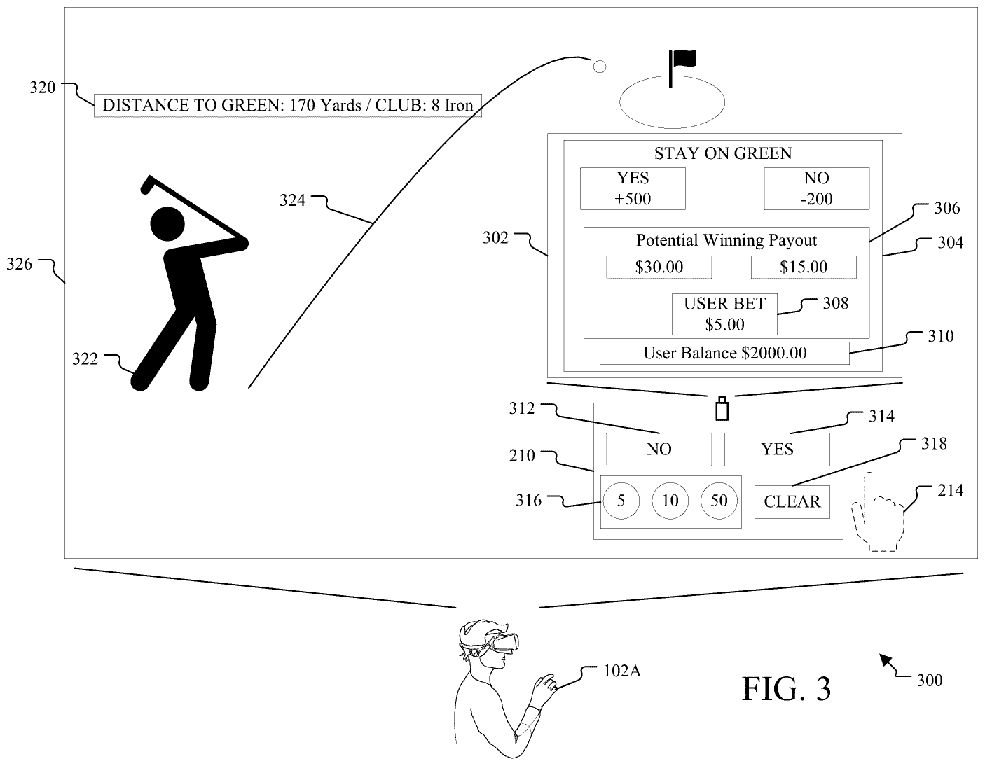

FIG. 3 depicts an exemplary overlay for an event with interactive elements for a VR device, according to aspects described herein. As shown in FIG. 3, the user is viewing a content stream from viewing angle 326 relating to a golf sporting event. The VR device 102A may be displaying the viewing angle 326 with a golfer 322 hitting a ball toward the green as the primary content for the display. There are several overlays with various interactive elements displayed within them. For example, overlay 320 is an information overlay providing information to the user such as distance to the green and the club that the player 322 is using. The overlay 320 is transparent such that the flight path of the ball 324 which is presented as part of the content stream is visible through the overlay 320. Thus, the overlay does not diminish the underlying viewing experience of the content stream but rather, enhances it with beneficial information.

Additionally, overlay 302 is presented with other interactive elements for user consideration, in this case the interactive elements are related to sports betting opportunities based on whether the players 322 ball will stay on the green. Interactive element 304 may have a plurality of interactive elements and information overlays for display. For example, interactive element 306 may include a simplified betting experience option where the user bet 308 is clearly noted with potential winning payouts shown in monetary value, $30.00 and $15.00 respectively, with the traditional betting odds displayed above and corresponding to the simplified monetary values. A user balance 310 may be shown for ease of reference. The user may provide gesture input, as described above to select one or more bets on the console 210 as shown. In FIG. 3, console 210 includes yes interactive element 314 and no interactive element 312 in addition to a clear interactive element 318 which will clear the bet amount. Interactive element 316 includes one or more tokens representing various monetary amounts for betting, in this case 5, 10, and 50. The interest indicator engine 124, may provide recommendations on what the values should be for the tokens based on one or more interest indicators including past betting history and betting amounts the user has placed. These recommendations provide a personalized experience for the user and simplifies the betting experience. In this example, the user may provide gesture input to bet $5.00 at user bet 308, with an option to win $30.00. Although not pictured, when the user provides this input to the system 300, the workflow processor 132 would perform the steps of placing the bet including deducting the $5.00 bet from the user balance, which would change the displayed value to $1995.00.

As shown in FIG. 3, the overlay 302 may be positioned in a place that does not obscure the user's view of the game. The position of the overlay 302 may be adjusted in real-time as the user changes their view, by the display engine 128 using one or more computer vision techniques to determine the position of the viewing angle 326 as the user adjusts their view. Upon identifying these aspects of the viewing angle 326, the overlay 302 may automatically be moved to a position that does not overlap, or minimally overlaps, the ongoing game.

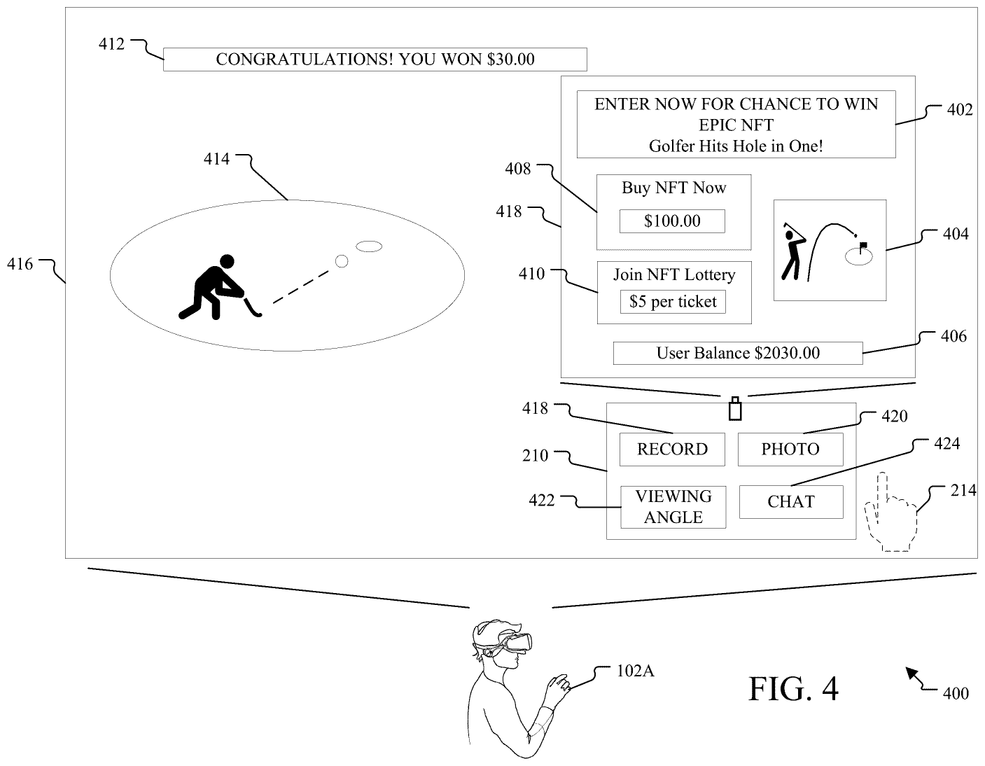

FIG. 4 depicts an exemplary overlay for an event with interactive elements for generating and purchasing an NFT on a VR device, according to aspects described herein. This may be a subsequent viewing angle 416 of a different golfer putting 414. The user may have provided gesture input to change views to the present viewing angle 416. An information overlay 412 may be presented indicating the user won their last bet and the user balance 406 may have been updated to show the win and now shows $2030.00 in the user's account. Additionally, the interest indicator engine 124 may have requested an NFT 404 be generated from the previous viewing angle 326 in FIG. 3 because the player hit a hole in one. Overlay 418 may now include interactive elements relating to entering a contest, in this case a lottery, to win the NFT 404 of the hole in one. Lottery interactive element 410 may include options to buy one or more tickets for $5 or if the user prefers, they can buy the NFT outright for $100.00 via interactive element 408.

Additionally, FIG. 4 depicts another console 210 layout which includes additional control interactive elements 418, 420, 422, and 424 which allow the user to control their VR experience further. As depicted in FIG. 4, the VR overlay may contain controls which allow the user to take a picture of their current view via interactive element 420, start a recording of their view via interactive element 418, and/or open a chat or call to other users watching the game via interactive element 424. Still further, the VR overlay may include a gallery of pictures or videos that the user captured during the game in interactive element, which is not shown. Additional control may allow the user to change their viewing angle of match via interactive element 422.

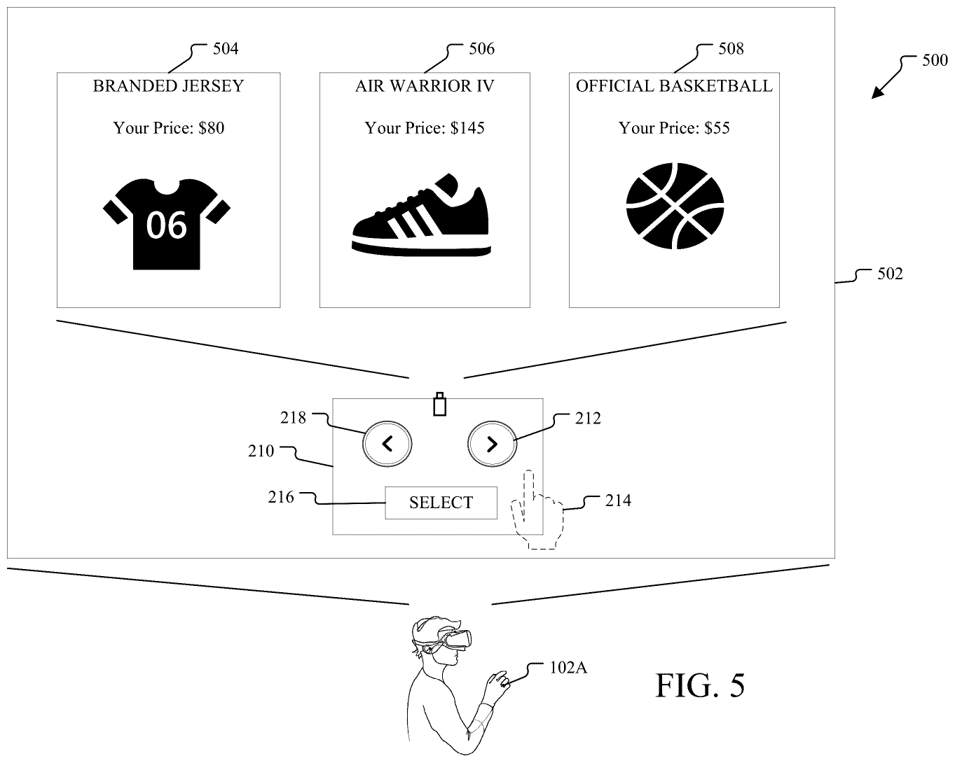

FIG. 5 depicts yet another exemplary overlay for an event with interactive elements for a VR device, according to aspects described herein. In FIG. 5, the user has selected to enter an online shopping overlay 502 with one or more associated items 504, 506, and 508 from the content stream available for purchase. The console 210 includes left arrow 218 and right arrow 212 for scrolling through the items, although in some examples the user may be able to scroll through the interactive elements 504, 506, and 508 via gesture input as well. If the user wants to purchase one of the items such as the pair of shoes in interactive element 506, they may provide gesture input and/or physical input to move the cursor 214 over the select button 216 to provide confirming input of the purchase. This confirming input may trigger a workflow to purchase the item by the workflow processor 132.

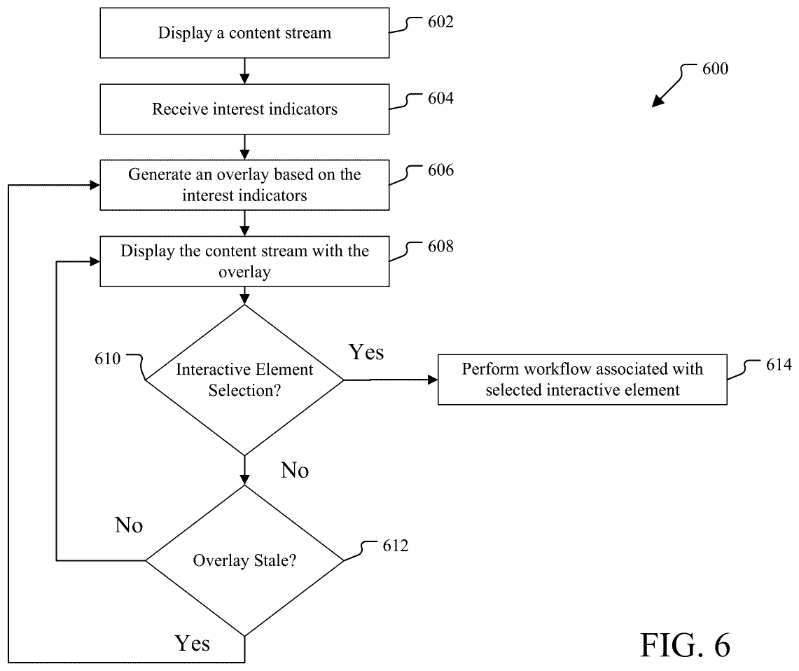

FIG. 6 is a block diagram illustrating a method for generating an overlay for an event on a VR device, according to aspects described herein. Flow begins with operation 602 where the content stream is displayed on a VR device (e.g., VR device 102) by a content processor (e.g., content processor 122). The content processor Flow progresses to operation 604 where one or more interest indicators may be collected by an interest indicator engine (e.g., interest indicator engine 124). The interest indicators may be related to a variety of information which may be utilized by the interest indicator engine to provide recommendations on overlays and interactive elements in the overlay.

At operation 606, one or more overlays may be generated by an overlay generator (e.g., overlay generator 126) for display with the content stream. The overlays may include information and/or interactive elements associated with the content to enhance the users viewing experience. In examples, interactive elements enabling the user to purchase items, place bets, create personalized photos and videos, generate NFTs, and/or change viewing angle of the content stream among a plurality of other options may be offered to the user. In some examples, the overlays may be personalized for the user based on the one or more interest indicators associated with the user. At operation 608, the generated overlays may be displayed with the content stream by the display engine (e.g., display engine 128). The overlays may be transparent and/or translucent and positioned on the content stream to enhance the viewing experience without reducing it.

At operation 610, where the overlay interaction manager (e.g., overlay interaction manager 130) determines if an interactive element is selected by the user. If an interactive element is not selected, flow progresses to operation 612, which determines if the overlay is stale or not. A stale overlay is one which is no longer applicable to the content stream. An overlay interaction manager may determine if an overlay is stale or not based on a variety of factors including, if the content stream has transitioned to a different piece of content, if the viewing angle is changed, if the offer made in the interactive element is no longer applicable (e.g., the offer is for a live bet related to a free throw, but the free throw occurred), a timer associated with the overlay has timed out, the user has indicated that they are not interested in the interactive element associated with the overlay, and/or many other options which will be understood by one having skill in the art. If an overlay is stale, flow progresses to operation 606, where new overlays will be generated based on the interest indicators. If the overlay is not stale, flow progresses to operation 608, where the overlay will continue to be displayed with the content stream until either an interactive element is selected and/or the overlay is determined to be stale.

Returning to operation 610, if an interactive element is selected the overlay interaction manager will direct the workflow processor (e.g., workflow processor 132) to perform the workflow associated with the selected interactive element. There is a plurality of workflows which could be processed by the workflow processor, as described herein.

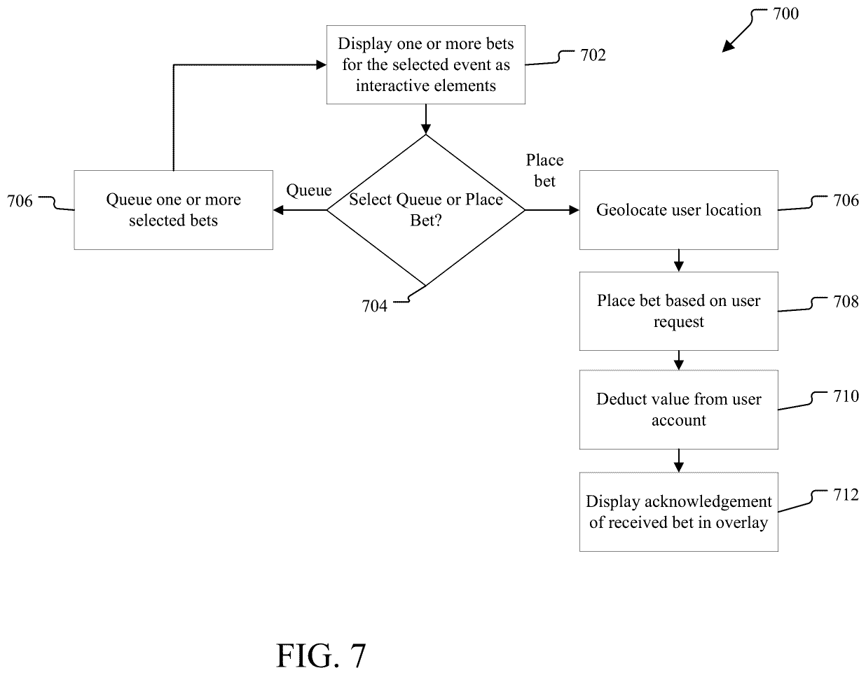

FIG. 7 is a block diagram illustrating a method for performing a workflow associated with betting interactive elements, according to aspects described herein. Flow begins with operation 702 where one or more bets associated with the content stream are displayed as interactive elements in an overlay. At operation 704, the user may provide gesture input and/or physical input on a physical device and the overlay interaction manager 130 may determine if the user is requesting to queue or place the bet. In instances where the user is queueing the bet, flow progresses to operation 706 where the bet is queued in the user account in data storage (e.g., data storage 114) for a later time. This may occur because the user wishes to consider the bet before placing it. In other examples, the user may queue one or more bets to create a parlay, or combined bet, where multiple offered bets are combined into a single bet with a single combined odds. The queued bets may be saved for the user to consider several optional combinations and combined odds before placing the parlay bet. Alternatively, it may occur because the current location of the VR device (e.g., VR device 102) or intermediate device (e.g., mobile device 104 and computing device 106) cannot be geo-located to meet certain regulatory requirements associated with placing a bet. The user may access their user profile to view queued bets and provide input to delete the queued bet or place the bet.

Returning to operation 704, if the user requests to place the bet flow progresses to operation 706 where the system confirms the current location of the VR device (e.g., VR device 102) or intermediate device (e.g., mobile device 104 and computing device 106). Based on regulatory requirements related to betting, the current location of the device may need to be confirmed prior to placing a bet. The workflow processor (e.g., workflow processor 132) may determine the current location of the VR device 102 and if it satisfies regulatory requirements, flow may progress to operation 708 where the workflow processor may place the bet based on the user request. At operation 710 the workflow processor may deduct the monetary value associated with the bet from the user account maintained on data storage 114. This deduction may be reflected by an updated interactive element associated with the user account on an overlay. At operation 712, an overlay generator (e.g., overlay generator 126) may generate an overlay confirming the users bet was placed and the display engine (e.g., display engine 128) may display the overlay on the content stream.

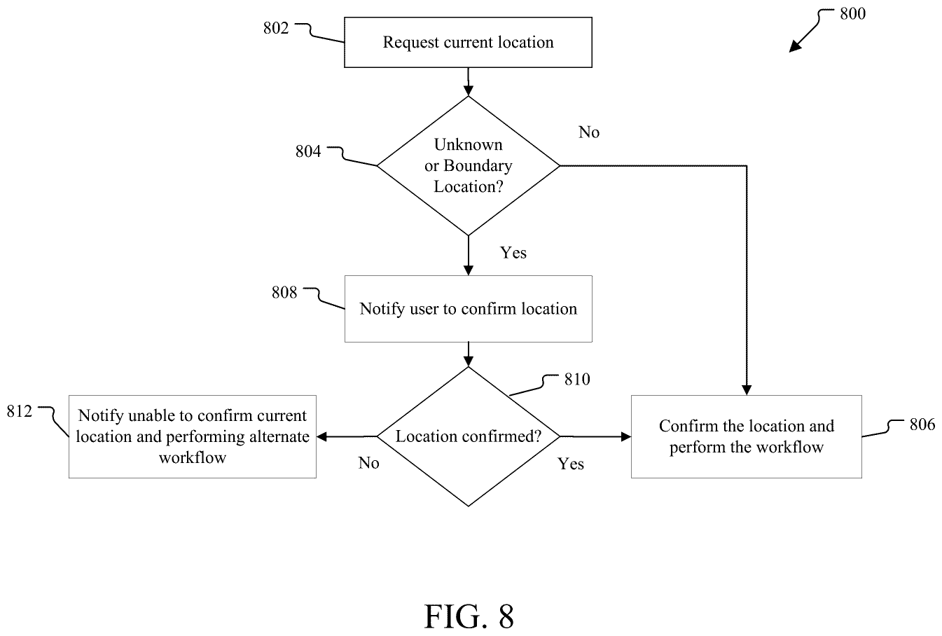

FIG. 8 is a block diagram illustrating a method for geo-locating the VR device, according to aspects described herein. Flow begins at operation 802, where the current location of the of VR device 102 is requested. The workflow processor (e.g., workflow processor 132) may request the current location of the VR device (e.g., VR device 102) from a location enabled device. In examples where the VR device itself is capable of performing location services, the VR device will determine its current location and return it to the workflow processor. In examples where the VR device utilizes an intermediate device (e.g., mobile device 104 or computing device 106) to perform location services, the request will be processed by the applicable intermediate device.

At operation 804, it is determined if the current location is an unknown or boundary location. An unknown location is a situation where for some reason the current location is unable to be determined and/or provided to the workflow processor (e.g., workflow processor 132). This may occur due to location services being disabled on the VR device (e.g., VR device 102) and/or on the intermediate device (e.g., mobile device 104 and computing device 106), location services being unavailable due to a network connectivity issue, the VR device being too distant from the intermediate device, and/or a variety of other reasons. A boundary location is a location that is close enough to a regulatory boundary that the workflow processor cannot determine if the current location is within the regulatory area that permits betting or if the current location is within the regulatory area that restricts betting. For example, a user could be on a boat in a harbor using their VR device, which may be close to a boundary location between two states where state A permits betting and state B restricts betting. Based on the movement of the boat in the harbor, the location on the water, etc. the current location may be classified a boundary location. Both the unknown location and boundary location determinations exist to ensure that the system does not place a bet from a location where a user is restricted from placing a bet, based on applicable jurisdiction regulations. If the current location is known and not a boundary location flow progresses to operation 806 where the workflow processor (e.g., workflow processor 132) will confirm the location and perform the workflow associated with the location request. In many cases the associated workflow will be to place a bet, as described herein.

Returning to operation 804, if the current location is an unknown and/or boundary location, flow progresses to operation 808 where a notification will be displayed to requesting the user confirm their location. The workflow processor (e.g., workflow processor 132) will request an overlay be generated by the overlay generator (e.g., overlay generator 126) for display on the VR device (e.g., VR device 102) requesting the user confirm their location. The overlay may include additional instructions and/or a link to a separate overlay providing instructions for how to confirm the location and a separate interactive element for the user to select when the instructions have been followed. Confirming the location may involve moving the VR device closer to the intermediate device (e.g., mobile device 104 and computing device 106) to ensure the current location when the bet is placed is within the permitted regulatory area, enabling location services on the VR device and/or intermediate device, changing the position of the location enabled device and reattempting the location request, among other options. One or more of the options may be performed by the user, who may then select the interactive element to reattempt the location request.

Flow progresses to operation 810, where it is determined if the location is confirmed. If the reattempt is successful, meaning the location can be confirmed as within a permitted area, flow progresses to operation 806 where the workflow processor (e.g., workflow processor 132) will confirm the location and perform the workflow associated with the location request. In many cases the associated workflow will be to place a bet, as described herein. Returning to operation 810, if the reattempt is unsuccessful, flow progresses to operation 812 where a subsequent overlay is generated by the overlay generator (e.g., overlay generator 126) informing the user that the current location cannot be confirmed, the bet cannot be placed due to regulatory restrictions, and/or recommending alternative workflows (e.g., queueing the bet for later, offering alternative overlays, additional instructions to reattempt a location request, etc.).

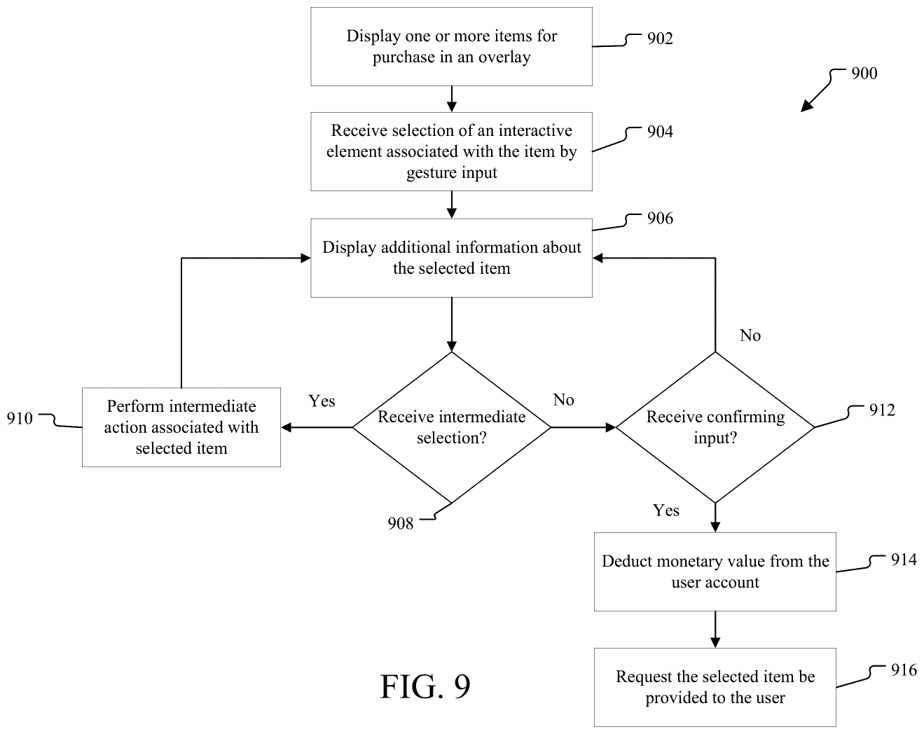

FIG. 9 is a block diagram illustrating a method for performing a workflow associated with making a purchase via the VR device, according to aspects described herein. Flow begins at operation 902 where one or more items are displayed for purchase as interactive elements within an overlay by a display engine (e.g., display engine 128). Items for purchase may be products associated with the content, an NFT, food and beverage items from an overlay, a lottery ticket, and/or a plurality of other items one having skill in the art will be familiar with. Flow progresses to operation 904, a selection of an item is received via gesture input and/or physical input on a physical device. This selection initiates the purchase workflow for the workflow processor (e.g., workflow processor 132). Flow progresses to operation 906 where additional information about the selected item may be presented in an overlay. The additional information may include details associated with the item, the price, and taxes of the item, confirming details (e.g., mailing address, payment method, billing address, etc.), gift information, selection of size, color, and/or other attributes associated with the purchase of the item, etc. The additional information may be presented as interactive elements within the overlay if they require some user input.

Flow progresses to operation 908 where it is determined if an intermediate selection was received from the user. The intermediate selection may be a gesture and/or physical input related to the additional information described above, such as entering size information for the item and/or confirming payment details. If an intermediate selection is made, flow progresses to operation 910 where the workflow processor (e.g., workflow processor 132) will perform the action associated with the selection such as updating the billing address and reserving the item in the right size and color. From operation 910 flow would return to operations 906 and 908 until no additional intermediate selections are received.

Returning to operation 908, when no intermediate selection is received, flow progresses to operation 912 where it is determined if a confirming input is received. The overlay may include an option to confirm the purchase via an interactive element (e.g., a button, tab, slider, etc.) which may be selected via gesture and/or physical input. If the confirming input is not received flow progresses to operations 906 and back through to operation 912 until a confirming input is received. When a confirming input is received flow progresses to operation 914 where the monetary value for the item is deducted from the user account saved in data storage (e.g., data storage 114) by the workflow processor (e.g., workflow processor 132). At operation 916, the workflow processor requests the selected item be provided to the user as appropriate for the item. This may mean placing an order for an article of clothing from a distributor to be mailed to the users mailing address, placing a food order for delivery to the delivery address, making an NFT available to the user profile in data storage, and/or a plurality of other options based on the item type.

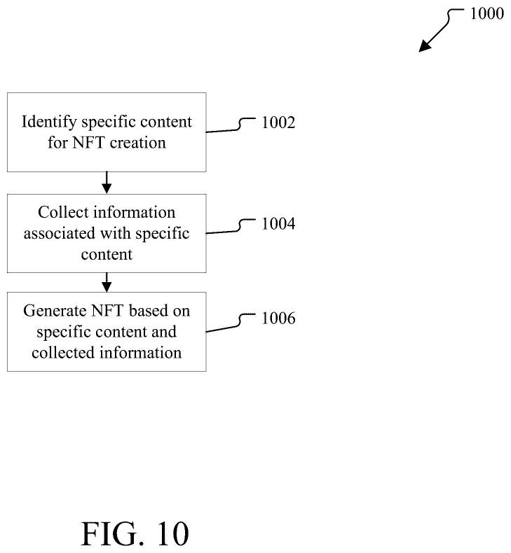

FIG. 10 is a block diagram illustrating a method for performing a workflow associated with creating a non-fungible token, according to aspects described herein. Flow begins with operation 1002, where specific content from the content stream is identified for NFT creation. The specific content may be identified manually by the user utilizing an interactive element on the console to record and capture an image and/or video from the content stream. The overlay interaction manager (e.g., overlay interaction manager 130) may track the users gesture inputs and capture the content per the manual input. Alternatively, the interest indicator engine (e.g., interest indicator engine 124) may automatically identify a moment from the content stream which could be used to generate an NFT based on an analysis of one or more interest indicators relating to the content.

Flow progresses to operation 1004, where information associated with the specific content will be collected to facilitate NFT creation by the workflow processor (e.g., workflow processor 132). This may include a timestamp of the event, information about who is in the content that will become an NFT (e.g., players and/or performers names, venue location, etc.), user information to customize the NFT, etc. Flow progresses to operation 1006, where the workflow processor will combine the content, collected information, and aspects of blockchain technology to create the NFT for the user.

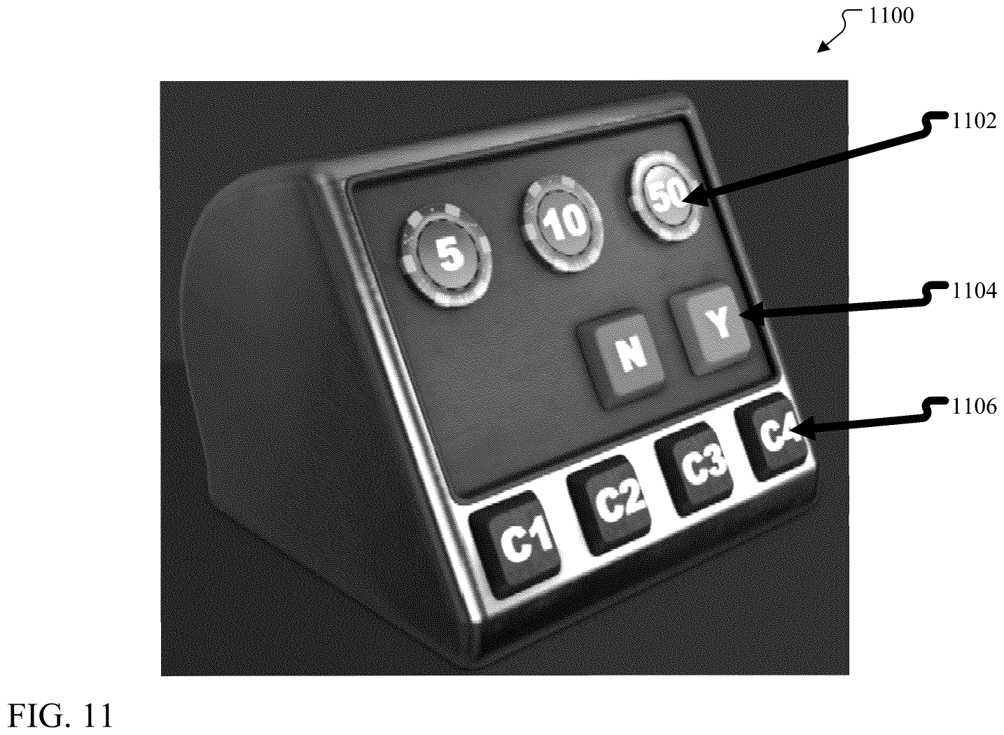

FIG. 11 depicts an exemplary console overlay for a VR device, according to aspects described herein. Console 1100 may be in the shape of a box-type console with a display face having one or more interactive elements which may be modified by the overlay generator based on the content type and overlay presented to the user. For example, the present console 1100 includes interactive element 1102 which is a fifty dollar betting chip for increasing a betting amount on the overlay. Interactive element 1104 is a yes interactive button, labeled “Y”, which permits the user to provide gesture input to confirm a selection. Interactive element 1106, labeled “C4” is a viewing angle button which if selected will transition the content stream to the camera four viewing angle. It will be appreciated by one having skill in the art, that there are a plurality of designs possible for overlays and interactive elements to provide the user control options, each of which are contemplated by this disclosure.

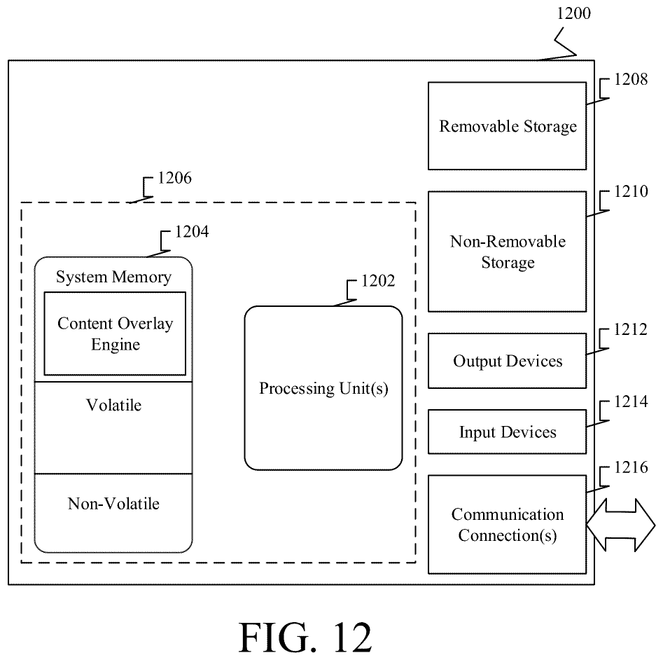

FIG. 12 illustrates a simplified block diagram of a device with which aspects of the present disclosure may be practiced, according to aspects described herein. The device may be a mobile computing device or a VR device for example. One or more of the present embodiments may be implemented in an operating environment 1200. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1200 typically includes at least one processing unit 1202 and memory 1204. Depending on the exact configuration and type of computing device, memory 1204 (instructions to perform for performing the aspects disclosed herein) may be volatile (such as RAM), non-volatile (such as ROM, flash memory, etc.), or some combination of the two. This most basic configuration is illustrated in FIG. 12 by dashed line 1206. Further, the operating environment 1200 may also include storage devices (removable, 1208, and/or non-removable, 1210) including, but not limited to, magnetic or optical disks or tape. Similarly, the operating environment 1200 may also have input device(s) 1214 such as remote controller, keyboard, mouse, pen, voice input, on-board sensors, etc. and/or output device(s) 1212 such as a display, speakers, printer, motors, etc. Also included in the environment may be one or more communication connections, 1216, such as LAN, WAN, a near-field communications network, a cellular broadband network, point to point, etc.

Operating environment 1200 typically includes at least some form of computer readable media. Computer readable media can be any available media that can be accessed by the at least one processing unit 1202 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1200 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

According to an embodiment of the present disclosure, a system is disclosed comprising at least one processor, and memory storing instructions that, when executed by the at least one processor, cause the system to perform a set of operations, the set of operations comprising display a content stream on a virtual reality device, receive one or more interest indicators, wherein the interest indicators relate to one or more of the content stream and the user, generate an overlay based on the one or more interest indicators, wherein the overlay includes one or more interactive elements, display the content stream with the overlay on the virtual reality device, receive a selection of an interactive elements, and perform a workflow associated with the selected interactive elements.

In various embodiments of the disclosure, display the content stream with the overlay further comprises receive an indication that the overlay is stale, generate a subsequent overlay based on the one or more interest indicators, and display the content stream with the subsequent overlay.

In various embodiments of the disclosure, receive an indication that an overlay is stale comprises one or more of an expiration of a timer, an indication from the user that they are not interested in the overlay, and the occurrence of an action in the content stream indicating the overlay is stale.

In various embodiments of the disclosure, generate an overlay further comprises personalize the overlay for the user based on one or more interest indicators.

In various embodiments of the disclosure, the interest indicators comprise one or more of a content stream information, user profile information, user history information, user eye gaze history, product information, and common user characteristic information.

In various embodiments of the disclosure, geolocate the virtual reality device.

In various embodiments of the disclosure, geolocate the virtual reality device further comprises request the current location of the virtual reality device, determine if the current location is unknown location or a boundary location, when the current location is not an unknown location or a boundary location, confirm the location and perform a workflow associated with the request.

In various embodiments of the disclosure, receive a selection of an interactive element further comprises receive a gesture input or a physical input from a physical device of an interactive element.

In various embodiments of the disclosure, perform a workflow further comprises one or more of place a bet, purchase an item, interact with an interactive element of the overlay, transition to another aspect of the overlay, and select a viewing angle.

According to an embodiment of the present disclosure, a method is disclosed comprising displaying a content stream on a virtual reality device, receiving one or more interest indicators, wherein the interest indicators relate to one or more of the content stream and the user, generating an overlay based on the one or more interest indicators, wherein the overlay includes one or more interactive elements, displaying the content stream of the content stream with the overlay on the virtual reality device, receiving a selection of one or more of the interactive elements, and performing a workflow associated with the one or more selected interactive elements.

In various embodiments of the disclosure, display the content stream with the overlay further comprises receiving an indication that the overlay is stale, generating a subsequent overlay based on the one or more interest indicators, and displaying the content stream with the subsequent overlay.

In various embodiments of the disclosure, receiving an indication that an overlay is stale comprises one or more of an expiration of a timer, an indication from the user that they are not interested in the overlay, and the occurrence of an action in the content stream indicating the overlay is stale.

In various embodiments of the disclosure, generating an overlay further comprises personalizing the overlay for the user based on one or more interest indicators.

In various embodiments of the disclosure, the interest indicators comprise one or more of a content stream information, user profile information, user history information, user eye gaze history, product information, and common user characteristic information.

In various embodiments of the disclosure, geolocating the virtual reality device.

In various embodiments of the disclosure, geolocate the virtual reality device further comprises requesting the current location of the virtual reality device, determining if the current location is unknown location or a boundary location, when the current location is not an unknown location or a boundary location, confirming the location and performing a workflow associated with the request.

In various embodiments of the disclosure, receive a selection of an interactive element further comprises receiving a gesture input or a physical input from a physical device of an interactive element.

In various embodiments of the disclosure, performing a workflow further comprises one or more of placing a bet, purchasing an item, interact with an interactive element of the overlay, transitioning to another overlay, and selecting a viewing angle.

According to an embodiment of the present disclosure, a computer storage media is disclosed including instructions, which when executed by a processor, cause the processor to display a content stream on a virtual reality device, receive one or more interest indicators, wherein the interest indicators relate to one or more of the content stream and the user, generate an overlay based on the one or more interest indicators, wherein the overlay includes one or more interactive elements, display the content stream of the content stream with the overlay on the virtual reality device, receive a selection of one or more of the interactive elements, and perform a workflow associated with the one or more selected interactive elements.

In various embodiments of the disclosure, display the content stream with the overlay further comprises receive an indication that the overlay is stale, generate a subsequent overlay based on the one or more interest indicators, and display the content stream with the subsequent overlay.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The methods and order of operations for a method disclosed herein are exemplary, such that the steps of the method may be reorganized, added to, combined, and/or steps may be omitted as is contemplated by one having skill in the art. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
display a content stream on a virtual reality device;
receive one or more interest indicators, wherein the interest indicators relate to one or more of the content stream and the user;
generate an overlay based on the one or more interest indicators, wherein the overlay includes one or more interactive elements;
display the content stream with the overlay on the virtual reality device;
receive a selection of an interactive elements; and
perform a workflow associated with the selected interactive elements.

2. The system of claim 1, wherein display the content stream with the overlay further comprises:
receive an indication that the overlay is stale;
generate a subsequent overlay based on the one or more interest indicators; and
display the content stream with the subsequent overlay.

3. The system of claim 2, wherein receive an indication that an overlay is stale comprises one or more of an expiration of a timer, an indication from the user that they are not interested in the overlay, and the occurrence of an action in the content stream indicating the overlay is stale.

4. The system of claim 1, wherein generate an overlay further comprises:
personalize the overlay for the user based on one or more interest indicators.

5. The system of claim 1, wherein the interest indicators comprise one or more of a content stream information, user profile information, user history information, user eye gaze history, product information, and common user characteristic information.

6. The system of claim 1, further comprises:
geolocate the virtual reality device.

7. The system of claim 6, wherein geolocate the virtual reality device further comprises:
request the current location of the virtual reality device;
determine if the current location is unknown location or a boundary location;
when the current location is not an unknown location or a boundary location, confirm the location and perform a workflow associated with the request.

8. The system of claim 1, wherein receive a selection of an interactive element further comprises receive a gesture input or a physical input from a physical device of an interactive element.

9. The system of claim 1, wherein perform a workflow further comprises one or more of place a bet, purchase an item, interact with an interactive element of the overlay, transition to another aspect of the overlay, and select a viewing angle.

10. A method comprising:
displaying a content stream on a virtual reality device;
receiving one or more interest indicators, wherein the interest indicators relate to one or more of the content stream and the user;
generating an overlay based on the one or more interest indicators, wherein the overlay includes one or more interactive elements;
displaying the content stream of the content stream with the overlay on the virtual reality device;
receiving a selection of one or more of the interactive elements; and
performing a workflow associated with the one or more selected interactive elements.

11. The method of claim 10, wherein display the content stream with the overlay further comprises:
receiving an indication that the overlay is stale;
generating a subsequent overlay based on the one or more interest indicators; and
displaying the content stream with the subsequent overlay.

12. The method of claim 11, wherein receiving an indication that an overlay is stale comprises one or more of an expiration of a timer, an indication from the user that they are not interested in the overlay, and the occurrence of an action in the content stream indicating the overlay is stale.

13. The method of claim 10, wherein generating an overlay further comprises:
personalizing the overlay for the user based on one or more interest indicators.

14. The method of claim 10, wherein the interest indicators comprise one or more of a content stream information, user profile information, user history information, user eye gaze history, product information, and common user characteristic information.

15. The method of claim 10, further comprises:
geolocating the virtual reality device.

16. The method of claim 15, wherein geolocate the virtual reality device further comprises:
requesting the current location of the virtual reality device;
determining if the current location is unknown location or a boundary location;
when the current location is not an unknown location or a boundary location, confirming the location and performing a workflow associated with the request.

17. The method of claim 16, wherein receive a selection of an interactive element further comprises receiving a gesture input or a physical input from a physical device of an interactive element.

18. The method of claim 10, wherein performing a workflow further comprises one or more of placing a bet, purchasing an item, interact with an interactive element of the overlay, transitioning to another overlay, and selecting a viewing angle.

19. A computer storage media including instructions, which when executed by a processor, cause the processor to:
display a content stream on a virtual reality device;
receive one or more interest indicators, wherein the interest indicators relate to one or more of the content stream and the user;
generate an overlay based on the one or more interest indicators, wherein the overlay includes one or more interactive elements;
display the content stream of the content stream with the overlay on the virtual reality device;
receive a selection of one or more of the interactive elements; and
perform a workflow associated with the one or more selected interactive elements.

20. The computer storage media of claim 19, wherein display the content stream with the overlay further comprises:
receive an indication that the overlay is stale;
generate a subsequent overlay based on the one or more interest indicators; and
display the content stream with the subsequent overlay.
